(19) United States
(12) Patent Application Publication
(10) Pub. No.: US 2008/0187849 A1
(43) Pub. Date: Aug. 7, 2008

(54) Electrophotographic apparatus

(75) Inventors: Sayaka Fujita, Kashihara-shi (JP); Kotaro Fukushima, Kawanishi-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 12/068,406

(22) Filed: Feb. 6, 2008

(30) Foreign Application Priority Data
Feb. 6, 2007 (JP) 2007-26952

(51) Int. Cl. G03G 15/08

(52) U.S. Cl. 430/84

(57) ABSTRACT

An electrophotographic apparatus comprising an electrophotographic photoreceptor having the foremost layer containing organic fine particles and inorganic fine particles, which uses a dry-type magnetic toner having a charge amount of 10.0 μc/g or more and 30.0 μc/g or less.

### CROSS-REFERENCE TO RELATED APPLICATION

This application is related to Japanese application No. 2007-26952 filed on Feb. 6, 2007, whose priority is claimed under 35 USC §119, the disclosure of which is incorporated by reference in its entirety.

### BACKGROUND OF THE INVENTION

1. Field of the Invention

The present invention relates to an electrophotographic apparatus. More specifically, the present invention relates to an electrophotographic apparatus used in image forming with an electrophotographic system.

2. Description of the Related Art

An image forming apparatus with an electrophotographic system (hereinafter also referred to as an electrophotographic apparatus) used as a copying machine, a printer, and a facsimile apparatus forms an image by going through an electrophotographic process as follows. First, a photosensitive layer of an electrophotographic photoreceptor (simply referred to as a photoreceptor hereinbelow) equipped in the apparatus is charged evenly to a prescribed potential by a charger. Then, an electrostatic latent image is formed on the photosensitive layer by exposing the photosensitive layer with a light such as a laser light irradiated from an exposure means according to image information. A developer is supplied from a developing means to the formed electrostatic latent image. By this supply, the electrostatic latent image is developed by attaching colored fine particles called a toner that is a component of the developer on the surface of the photoreceptor. The electrostatic latent image is developed as a toner image. The formed toner image is transferred onto a transfer material such as a recording paper from the surface of the photoreceptor by a transfer means, and fixed by a fixing means.

During the transfer operation by the transfer means, not all of the toner on the surface of the photoreceptor is transferred and shifted to the recording paper, but a part of it remains on the surface of the photoreceptor. Further, there is also a case that paper powder of the recording paper contacting with the photoreceptor remains attached on the surface of the photoreceptor when transferred. Because such foreign objects such as a remaining toner and attached paper powder on the surface of the photoreceptor have an adverse effect on the quality of the formed image, they are removed by a cleaning device. Further, in recent years, the foreign objects are removed with a cleaner-less technique. Specifically, the remained toner and the foreign objects are removed by a developing and cleaning system without providing an independent cleaning means, more specifically, by a cleaning function given to the developing means. After the surface of the photoreceptor is cleaned in such a way, the surface of the photoreceptor is destaticized with a destaticizer etc., and the electrostatic latent image is eliminated.

The electrophotographic photoreceptor used in such an electrophotographic process has a configuration in which the photosensitive layer including a photoconductive material is layered on a conductive substrate made of a conductive material. Conventionally, an electrophotographic photoreceptor using an inorganic photoconductive material (hereinafter referred to as an inorganic photoreceptor) has been used as the electrophotographic photoreceptor. Typical examples of the inorganic photoreceptor include a selenium photoreceptor using a layer containing amorphous selenium (a-Se), amorphous selenium-arsenic (a-AsSe), etc. in a photosensitive layer, a zinc oxide or cadmium sulfate photoreceptor in which zinc oxide (chemical formula: ZnO) or cadmium sulfate (chemical formula: CdS) dispersed in a resin together with a sensitizer such as a pigment is used in the photosensitive layer, and an amorphous silicon photoreceptor in which a layer containing amorphous silicon (a-Si) is used in the photosensitive layer (hereinafter referred to as an a-Si photoreceptor).

However, the inorganic photoreceptor has the following disadvantages. The selenium photoreceptor and the cadmium sulfate photoreceptor have a problem in heat resistance and storage stability. Further, because selenium and cadmium have toxicity to a human body and an environment, there is a necessity of collecting and appropriately disposing the photoreceptor using these after use. Further, the zinc oxide photoreceptor has the disadvantages of low sensitivity and low durability, and it is hardly used at present. Further, the a-Si photoreceptor attracted attention as a pollution-free inorganic photoreceptor has advantages such as high sensitivity, high durability, etc. Contrarily, because it is manufactured using a plasma chemical vapor growth method, it has disadvantages such that it is difficult to uniformly form the photosensitive layer, that image defects can easily be generated, etc. Further, the a-Si photoreceptor also has disadvantages such that productivity is low and manufacturing cost is high.

Because there are many disadvantages in the inorganic photoreceptor as described above, the development of a photoconductive material used in an electrophotographic photoreceptor is proceeded, and an organic photoconductive material, that is an organic photoconductor (abbreviated as OPC) has been used often instead of the inorganic photoconductive material. The electrophotographic photoreceptor using the organic photoconductive material (hereinafter referred to as an organic photoreceptor) has some problems in sensitivity, durability, stability to an environment, etc. However, it has many advantages from the viewpoint such as toxicity, a manufacturing cost, freedom of material design, etc. as compared with the inorganic photoreceptor. Further, the organic photoreceptor also has an advantage such that the photosensitive layer can be formed with an easy and less expensive method represented by a dip coating method. Because it has many advantages as described above, the organic photoreceptor is gradually becoming the mainstream electrophotographic photoreceptor. Further, with research and development in recent years, sensitivity and durability of the organic photoreceptor have been improved, and at present, the organic photoreceptor has been used as the electrophotographic photoreceptor except in special cases.

Especially, the performance of the organic photoreceptor is remarkably improved by the development of a function separating photoreceptor in which each of a charge generating function and a charge transporting function had to a different substance. The function separating photoreceptor has a broad range of the selection of materials constituting a photosensitive layer, and also has an advantage that a photoreceptor having an arbitrary characteristic can be relatively easily produced in addition to the above-described advantages that the organic photoreceptor has.

There are a multilayer photoreceptor and a single-layer photoreceptor in the function separating photoreceptor. The multilayer function separating photoreceptor is equipped with a multilayer photosensitive layer having a configuration in which a charge generating layer containing a charge generating substance that carries a charge generating function and a charge transporting layer containing a charge transporting substance that carries a charge transporting function are layered. The charge generating layer and the charge transporting layer normally have a configuration in which the charge generating substance and the charge transporting substance are dispersed respectively into a binding resin that is a binder. Further, the single-layer function separating photoreceptor is equipped with a single-layer photosensitive layer formed by both the charge generating substance and the charge transporting substance dispersed in the binding resin.

Further, in the electrophotographic apparatus, the above-described operation of charging, exposing, developing, transferring, cleaning, and destaticizing are repeatedly performed on the photoreceptor under various environments. Because of that, excellent environmental stability, electrical stability, and durability against a mechanical external force (printing resistance) are required in the photoreceptor in addition to high sensitivity and an excellent photo response property. Specifically, the surface layer of the photoreceptor is required to hardly wear by rubbing due to a cleaning member, etc.

A technique of providing a protective layer on the foremost surface layer of a photoreceptor (Japanese Unexamined Patent Publication No. SHO 57(1982)-30846), a technique of giving lubricity to a protective layer (Japanese Unexamined Patent Publication No. HEI 1(1989)-23259), a technique of curing a protective layer (Japanese Unexamined Patent Publication No. SHO 61(1986)-72256), and a technique of containing filler particles in a protective layer (Japanese Unexamined Patent Publication No. HEI 1(1989)-172970) are known as techniques to improve printing durability of the photosensitive layer. These protective layers are basically desired to be made as thin as possible from the viewpoint that they do not hinder the basic function of a photosensitive layer. Further, by providing a protective layer, various harmful effects occur. For example, in the case that the photoreceptor and the protective layer have a discontinuous layer structure, the protective layer may be peeled by a long-term use. Further, a potential at an exposed part increases due to repeated use for a long time. Contrarily, in the case that the protective layer and the photosensitive layer have a continuous layer structure, its layer structure can be formed by the photosensitive layer being dissolved by a protective layer paint applied continuously thereon. In this case, image characteristics of the photosensitive layer deteriorate by the dissolved condition of the photosensitive layer. Furthermore, when the dielectric constant of the protective layer becomes nonuniform, image fattening and toner scattering occur at an edge part of a black solid image when outputting a black solid image. In the case that the protective layer contains filler particles, etc., such a tendency becomes remarkable. In order to keep printing resistance only with a thin surface layer such as a protective layer and keep desired photoreceptor characteristics, the preferred condition of an added amount of the filler particles frequently becomes about 10 wt % or more to the entire solid content of the protective layer.

When the printing resistance is improved, as its harmful influence, image blur and image flow influenced by charged products, etc. attached on the surface of a drum occur especially under high temperature and high humidity. A technique of providing a uniform and inert drum surface by a method of designing it so that a photoreceptor can be “shaved” at some degree or a method of giving a device in a cleaning means as a method of eliminating this harmful influence is reported (Japanese Unexamined Patent Publication No. 2004-61560).

If wear resistance effect can be given to the foremost surface of the function separating photoreceptor, there is no necessity to include an extra step in a production process of the photoreceptor. Accordingly, there is a large merit in the cost compared with the case of forming the protective layer. Further, the above-described harmful influence occurring by providing the photosensitive layer and the protective layer by laminating can be avoided. However, on the other hand, it becomes necessary to consider new problems in the apparatus system. For example, when attempting to improve the printing resistance by adding filler particles, a trap is generated on the entire charge transporting layer extending a few 10 μm between the filler particles and a polymer bulk contained in the photosensitive layer (a binding resin). As a result, a risk that invites an increase of the remaining potential in the exposed part becomes extremely large compared with the case of adding into the protective layer. Further, in the case of the multilayer photoreceptor, there is also a case that an image defect occurs that is originated from non-uniformity of a layer near the interface between the charge generating layer and the charge transporting layer that is considered due to an interaction of the charge generating layer with the filler particles.

Further, in order to achieve high image quality, not only does improvement of the characteristics of the electrophotographic photoreceptor become necessary but also optimization of the toner charge amount becomes necessary. For example, in the case that the toner charge amount is 10.0 μc/g or less, toner scattering becomes large at developing or at physical vibration. The scattered toner not only contaminates the inside of the apparatus but also is attached on an image as a stain. On the other hand, in the case that the charge amount is 30.0 μc/g or more, charge-up of the toner becomes remarkable when the developer is stirred. This charge-up causes, for example, a phenomenon of which image concentration does not appear in a system of inversion development. Contrarily to this, when the charge amount is 10.0 μc/g or more and 30.0 μc/g or less, a good image can be obtained steadily without generating toner scattering and lowering of the image concentration.

However, in the case of using a dry-type magnetic toner having a charge amount of 10.0 μc/g or more and 30.0 μc/g or less, a mold releasing property of the toner from the photoreceptor is poor. As a result, a remaining toner increases on the electrophotographic photoreceptor and a uniform image cannot be obtained. Then, an electrophotographic apparatus in which fine resin particles containing fluorine atoms is contained in the surface layer of the electrophotographic photoreceptor is proposed (Japanese Unexamined Patent Publication No. HEI 6(1994)-95416). However, in this method, mechanical strength of the surface layer becomes insufficient, and an electrophotographic apparatus with a long life cannot be provided.

### SUMMARY OF THE INVENTION

An object of the present invention is to provide an electrophotographic apparatus that can obtain high quality images over a long term without being affected by the mold release property of a toner by simultaneously containing organic fine particles and inorganic fine particles in the surface layer of an electrophotographic photoreceptor.

Thus, according to the present invention, it is provided that an electrophotographic apparatus comprising an electrophotographic photoreceptor having the foremost layer containing organic fine particles and inorganic fine particles, which uses a dry-type magnetic toner having a charge amount of 10.0 μc/g or more and 30.0 μc/g or less.

From another viewpoint, according to the present invention, it is provided that a method in which a dry-type magnetic toner having a charge amount of 10.0 μc/g or more and 30.0 μc/g or less is used in an electrophotographic apparatus equipped with an electrophotographic photoreceptor having the foremost layer containing organic fine particles and inorganic fine particles.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a partial cross-sectional view simplifying a configuration of an electrophotographic photoreceptor of the present invention.

FIG. 2 is a partial cross-sectional view simplifying a configuration of an electrophotographic photoreceptor of the present invention.

FIG. 3 is a side view simplifying of an electrophotographic apparatus of the present invention.

FIG. 4 is an explanatory drawing of a device measuring the frictional electrification amount.

### DESCRIPTION OF THE PREFERRED EMBODIMENTS

The present invention is explained in detail below.

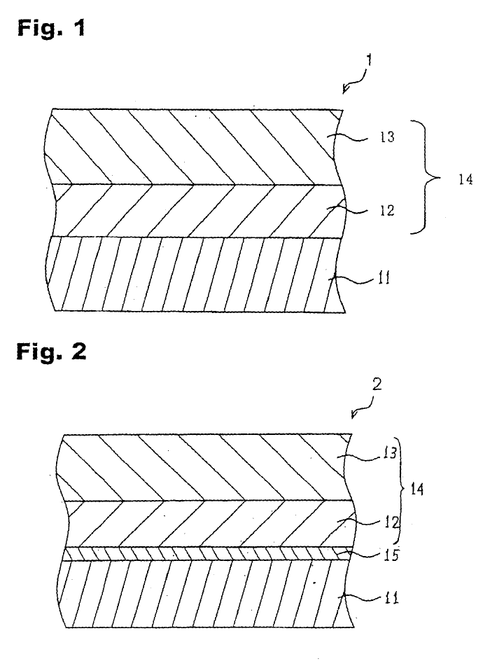

FIG. 1 is a partial cross-sectional view simplifying a configuration of an electrophotographic photoreceptor 1 that is a first embodiment of the present invention. The electrophotographic photoreceptor 1 in the embodiment of the present invention (hereinafter abbreviated as a photoreceptor) includes a cylindrical conductive substrate 11 made of a conductive material, a charge generating layer 12 containing a charge generating substance that is a layer laminated on the outer peripheral surface of the conductive substrate 11, and a charge transporting layer 13 containing a charge transporting substance that is a layer further laminated on the charge generating layer 12. The charge generating layer 12 and the charge transporting layer 13 constitute a photosensitive layer 14. That is, the photoreceptor 1 is a layered photoreceptor. The charge means an electron or a hole.

Further, an intermediate layer may be provided between the conductive substrate 11 and the charge generating layer 12.

### (Conductive Substrate)

The conductive substrate 11 functions as a supporting member of each of other layers 12 and 13 while playing a role as an electrode of the photoreceptor 1. Moreover, the shape of the conductive substrate 11 is cylindrical in FIG. 1. However, it is not limited to this, and may be circularly cylindrical, sheet-like, endless belt-like, etc.

A metal element such as aluminum, copper, zinc, nickel, and titanium and an alloy such as an aluminum alloy and stainless steel can be used as examples of the conductive materials constituting the conductive substrate 11. Further, it is not limited to these metal materials, and a polymer material such as polyethylene terephthalate, nylon, and polystyrene, a material of which a metal foil (aluminum, gold, silver, copper, zinc, nickel, titanium) is laminated on the surface of a hard paper, a glass, etc., a material on which a metal (aluminum, gold, silver, copper, zinc, nickel, titanium) material is vapor-deposited, a material on which a layer of a conductive compound such as a conductive polymer, tin oxide, indium oxide is vapor-deposited or applied, etc. can be used. These conductive materials are processed into a prescribed shape and used.

An anode oxidation coating film treatment, a surface treatment by chemicals, hot water, etc., a coloring treatment, or a diffused reflection treatment of roughening the surface, etc. may be performed on the surface of the conductive substrate 11 within the range in which the image quality is not affected depending on necessity. In the electrophotographic process in which a laser is used as the exposure light source, the wavelength of the laser light is uniform. Therefore, the laser light reflected on the surface of the photoreceptor and the laser light reflected inside the photoreceptor could cause interference. The interference fringes due to this interference may appear on an image as a defect. By performing the treatments as described above on the surface of the conductive substrate 11, image defects due to the interference of this laser light with uniform wavelength can be prevented.

### (Charge Generating Layer)

The charge generating layer 12 contains the charge generating substance generating charges by absorbing light as a main component. The main component means a component that is contained at an amount of which its main function can be realized. Examples of an effective substance as the charge generating substance include an organic conductive material such as azo pigments such as a monoazo pigment, a bisazo pigment, and a trisazo pigment, indigo pigments such as indigo and thioindigo, perylene pigments such as peryleneimide and perylene acid anhydride, polycyclic quinone pigments such as anthraquinone and pyrenequinone, phthalocyanine pigments such as metal phthalocyanine and non-metal phthalocyanine, triphenylmethane pigments represented by Methyl Violet, Crystal Violet, Night Blue, Victoria Blue, etc., acridine pigments represented by Erythrosine, Rhodamine B, Rhodamine 3R, Acridine Orange, Frapeocine, etc., thiazine pigments represented by Methylene Blue, Methylene Green, etc., oxazine pigments represented by Capri Blue, Meldola Blue, etc., a suquarylium pigment, pyrylium salts, thiopyrylium salts, thioindego pigments, bisbenzoimidazole pigments, quinacridone pigments, quinoline pigments, lake pigments, azolake pigments, dioxazine pigments, azlenium pigments, triarylmethane pigments, xanthene pigments, cyanine pigments, and triphenylmethane pigments, and an inorganic conductive material such as selenium and amorphous silicon. One type of these charge generating substances may be used alone, or two types or more of these may be combined and used.

Among the above-described charge generating substances, an oxotitanium phthalocyanine compound represented by the following Formula (A) is preferably used.

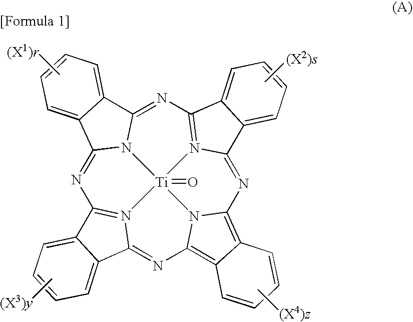

In the Formula, each X¹, X², X³, and X⁴ represents a halogen atom, an alkyl group, or an alkoxy group, and each r, s, y, and z represents an integer of 0 to 4.

Examples of a halogen atom represented with X¹, X², X³, and X⁴ in the formula (A) include a fluorine atom, a chlorine atom, a bromine atom, and an iodine atom.

Further, examples of an alkyl group represented with the above-described X¹, X², X³, and X⁴ include an alkyl group of C₁ to C₄ such as methyl, ethyl, propyl, isopropyl, butyl, isobutyl, and t-butyl group.

Furthermore, examples of the alkoxy group represented with the above-described X¹, X², X³, and X⁴ includes an alkoxy group of C₁ to C₄ such as methoxy, ethoxy, propoxy, isopropoxy, butoxy, isobutoxy, and t-butoxy group.

The oxotitanium phthalocyanine compound represented by the formula (A) is a charge generating substance having a high charge generation efficiency and a high charge implantation efficiency. Therefore, the charge generating layer 12 using the compound generates a large amount of charge by absorbing light, and it does not accumulate the generated charge inside. The charge is efficiently implanted into the charge transporting substance contained in the charge transporting layer 13, and then, it is smoothly transported to the surface of the photosensitive layer 14.

The oxotitanium phthalocyanine compound represented by the formula (A) can be manufactured by a known manufacturing method such as a method described in Phthalocyanine Compounds, Reinhold Publishing Corp., New York, 1963 by Moser, Frank H and Arthur L. Thomas, for example.

In the case of unsubstituted oxotitanium phthalocyanine in which r, s, y, and z is 0 in the oxotitanium phthalocyanine compound represented by the formula (A), it is obtained by synthesizing dichlorotitanium phthalocyanine by heating and melting phthalonitrile and titanium tetrachloride or heating and reacting in an appropriate solvent such as α-chloronaphthalene, and then by hydrolyzing with a base or water.

Further, oxotitanium phthalocyanine can be also manufactured by heating and reacting isoindoline and titanium tetraalkoxide such as tetrabutoxytitanium in an appropriate solvent such as N-methylpyrrolidone.

Examples of an arbitrary component other than the charge generating substance contained as the main component include a sensitizing dye, a binding resin, an antioxidant, a leveling agent, and a plasticizer.

Examples of the sensitizing dye include triphenylmethane dyes represented by methyl violet, crystal violet, night blue, Victoria blue, etc., acridine dyes represented by erythrosine, rhodamine B, rhodamine 3R, acridine orange, frapeosine, etc., thiazine dyes represented by methylene blue, methylene green, etc., oxazine dyes represented by Capri blue, meldola blue, etc., cyanine dyes, styryl dyes, pyrylium salt dyes, and thiopyrylium salt dyes. The sensitizer dye is preferably used at a ratio of 10 parts by weight or less to 100 parts by weight of the charge generating substance, and more preferably used at a ratio of 0.5 to 2 parts by weight.

Examples of the method of forming the charge generating layer 12 include a method of performing vacuum vapor deposition of the above-described charge generating substance on the surface of the conductive substrate 11 and a method of coating the surface of the conductive substrate 11 with a paint for the charge generating layer. Among these, a method of preparing a paint for the charge generating layer by dispersing the charge generating substance with a conventionally known method into a binding resin solution obtained by mixing a binding resin that is a binder into a solvent and coating the surface of the conductive substrate 11 with a paint, is preferably used. This method is explained below.

Examples of the binding resin used in the charge generating layer 12 include a polyester resin, a polystyrene resin, a polyurethane resin, a phenol resin, an alkyd resin, a melamine resin, an epoxy resin, a silicone resin, an acrylic resin, a methacrylic resin, a polycarbonate resin, a polyarylate resin, a phenoxy resin, a polyvinylbutyral resin, a polyvinylformal resin, and copolymerized resins containing two or more repeating units configuring these resins. A specific example of the copolymerized resin is an insulating resin such as a vinylchloride-vinylacetate copolymerized resin, a vinylchloride-vinylacetate-maleic anhydride copolymerized resin, and an acrylonitrile-styrene copolymerized resin. The binding resin is not limited to these, and a generally used resin can be used as the binding resin. One type of these resins may be used alone, and two or more types may be mixed and used.

Examples of the solvent of the paint for the charge generating layer used include halogenated hydrocarbon such as tetrachloropropane, dichloromethane, and dichloroethane, ketone such as acetone, isophorone, methyl ethyl ketone, acetophenone, and cyclohexanone, ester such as ethyl acetate, methyl benzoate, and butyl acetate, ether such as tetrahydrofuran (THF), dioxane, dibenzyl ether, 1,2-dimethoxyethane, and dioxane, aromatic hydrocarbon such as benzene, toluene, xylene, mesitylene, tetralin, diphenylmethane, dimethoxybenzene, and dicyclobenzene, a sulfur containing solvent such as diphenylsulfide, a fluorine solvent such as hexafluoroisopropanol, and an aprotic polar solvent such as N,N-dimethylformamide and N,N-dimethylacetamide. Further, two or more types of these solvents may be mixed. A non-halogen type organic solvent can be preferably used among these solvents in view of consideration for the global environment.

In the charge generating layer 12 configured by containing the charge generating substance and the binding resin, a ratio W1/W2 of a weight W1 of the charge generating substance to the weight W2 of the binding resin is preferably 10 hundredths ( 10/100) or more and 99 hundredths ( 99/100) or less. When the above-described ratio W1/W2 is less than 10/100, it is not preferable because sensitivity of the photoreceptor 1 decreases. When the above-described ratio W1/W2 exceeds 99/100, not only does film strength of the charge generating layer 12 decrease, but also dispersibility of the charge generating substance decreases and rough and large particles may increase. Therefore, surface charges on other than the part where they should be eliminated by exposure decreases, and image defects, especially a fogged image called a black spot (kuropoti) of which small black spots are formed when the toner attaches on a white background, may occur often. The ratio W1/W2 is more preferably 10/100 or more and 99/100 or less.

The charge generating substance may undergo a crushing process with a crusher in advance before being dispersed into the binding resin solution. Examples of the crusher that can be used in the crushing process include a ball mill, a sand mill, an attritor, a vibration mill, and an ultrasonic dispersion apparatus.

Examples of the dispersion apparatus that can be used when dispersing the charge generating substance into the binding resin solution include a paint shaker, a ball mill, and a sand mill. A dispersion condition at this time is preferably selected to be an appropriate condition so that mixing of impurities due to wear, etc. of the container that can be used and members configuring the dispersion apparatus does not occur.

Examples of the coating method of the paint for the charge generating layer include a spray method, a barcode method, a roll coating method, a blade method, a ring method, and a dip coating method. An appropriate method can be selected among these coating methods by taking the physical properties and productivity of the coating into consideration. Among these coating methods, the dip coating method is a method of forming a layer on the surface of a substrate by dipping the substrate in a coating bath filled with a paint and then pulling it up at a constant speed or at a speed changing continuously. Because the dip coating method is relatively simple as described above, and is superior in productivity and in the respect of a raw cost, it is often used in the case of manufacturing an electrophotographic photoreceptor. Moreover, a paint dispersion apparatus represented by an ultrasonic generating apparatus may be provided in the apparatus used in the dip coating method in order to stabilize dispersibility of the paint.

The film thickness of the charge generating layer 12 is preferably 0.05 μm or more and 5 μm or less, and more preferably 0.1 μm or more and to 1 μm or less. When the film thickness of the charge generating layer 12 is less than 5 μm, it is not preferable because efficiency of light absorption decreases and sensitivity of the photoreceptor 1 may decrease. When the film thickness of the charge generating layer 12 exceeds 5 μm, it is not preferable because charge movement inside the charge generating layer 12 becomes the rate-determining stage of the step of eliminating the surface charges of the photosensitive layer 14, and sensitivity of the photoreceptor 1 may decrease.

### (Charge Transporting Layer)

The charge transporting layer 13 is provided on the charge generating layer 12. The charge transporting layer 13 can be configured by including a charge transporting substance receiving a charge generated by the charge generating substance contained in the charge generating layer 12 and having an ability of transporting this and a binding resin having organic fine particles and inorganic fine particles as the main component and arbitrarily binding the charge transporting substance and the above-described particles. The binding resin is preferably contained in the range of 30 to 80% by weight to the entire charge transporting layer. An antioxidant, an ultra-violet absorbent, a leveling agent, a plasticizer, etc. may be contained other than the charge transporting substance, the organic fine particles, the inorganic fine particles, and the binding resin. A hole transporting substance and a charge transporting substance can be used as the charge transporting substance.

Examples of the hole transporting substance include a carbazoyl derivative, a pyrene derivative, an oxazole derivative, an oxadiazole derivative, a thiazole derivative, a thiadiazole derivative, a triazole derivative, an imidazole derivative, an imidazolone derivative, an imidazolidine derivative, a bisimidazolidine derivative, a styryl compound, a hydrazone compound, a polycyclic aromatic compound, an indole compound, a pyrazoline derivative, an oxazolone derivative, a benzimidazole derivative, a quinazoline derivative, a benzofuran derivative, an acridine derivative, a phenadine derivative, an aminostibene derivative, a tryarylamine derivative, a triarylmethane derivative, a phenylenediamine derivative, a stilbene derivative, an enamine derivative, and benzidine derivative. Further, examples of a polymer having a group generated from these compounds as the main chain or a side chain include poly-N-vinylcarbazole, poly-1-vinylpyrene, an ethylcarbazole-formaldehyde resin, a triphenylmethane polymer, poly-9-vinylanthracene, and polysilane.

An example of the charge transporting substance is an organic compound such as a benzoquinone derivative, a tetracyanoethylene derivative, a tetracyanoquinodimethane derivative, a fluorenone derivative, a xanthone derivative, a phenanthraquinone derivative, a phthalic anhydride derivative, and a diphenoquinone derivative.

The charge transporting substance is not limited to these given here. For its use, an individual type or two or more types can be mixed and used.

Furthermore, as charge transporting substance, by using a compound represented by the following formula (1) having resistance to gas such as NOx, a stable photoreceptor with less image deterioration can be formed even after a repeated use.

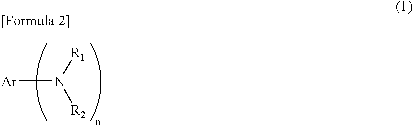

In the Formula, R1 and R2 may represent an alkyl group having 1 to 4 carbon atoms that may be the same or different from each other or R1 and R2 may form a heterocyclic ring group containing a nitrogen atom by bonding to each other, n represents an integer of 1 to 4, and Ar represents an aromatic ring group having a butadienyl group.

The binding resin configuring the charge transporting layer 13 is not especially limited, and any known resin in this field can be used. Especially, in the case of considering transparency of the film after coating, paint stability when the paint is produced, versatility, etc., a resin having polycarbonate as the main component is preferable. Here, the main component means a component occupying 50% by weight or more of the binding resin, and more preferably in the range of 60 to 100% by weight. Polycarbonate may be a copolymer formed with a monomer selected from siloxane, a fluorine skeleton, etc.

Examples of the resin other than polycarbonate include a vinyl polymer resin such as a polymethylmethacrylate resin, a polystyrene resin, and a polyvinyl chloride resin, a copolymer resin containing two or more repeating units configuring these, a polyester resin, a polyester carbonate resin, a polysulfone resin, a phenoxy resin, an epoxy resin, a silicone resin, a polyarylate resin, a polyamide resin, a methacrylic resin, an acrylic resin, a polyether resin, a polyurethane resin, a polyacrylamide resin, a phenol resin, and a polyphenylene oxide resin. Further, a thermosetting resin in which these resins are partially cross-linked is included. These resins may be used alone, or a mixture of two types or more may be used.

Furthermore, the charge transporting layer 13 as the foremost surface layer contains organic fine particles and inorganic fine particles. The organic fine particles are generally used for the purposes of controlling the wet property of the surface of the photoreceptor and suppressing the attachment of foreign objects, etc. The inorganic fine particles are used for the purpose of improving printing resistance. The organic fine particles exhibit wear resistance by decreasing the frictional force from an external stress with lubricity, and does not exhibit wear resistance by its hardness. In the present invention, by using both at the same time, a stress to the inorganic fine particles can be relieved with elasticity of the organic fine particles. Therefore, falling off of the inorganic fine particles can be suppressed, and the effect of the inorganic fine particles is more likely to be exhibited. On the other hand, the hardness of the organic fine particles is lower than that of the inorganic fine particles. However, because the inorganic fine particles also function as a supporter and a spacer of the organic fine particles, the hardness of the organic fine particles is supplemented by the inorganic fine particles. In this way, the organic fine particles and the inorganic fine particles can further raise each other's effect.

The organic fine particles are preferably particles comprising a fluorine-containing resin (for example, polyethylene fluoride, polypropylene fluoride, polyvinylidene fluoride, an ethylene fluoride-ethylene copolymer resin, etc.) Among these resins, polyethylene fluoride is more preferable.

The inorganic fine particles preferably have high hardness as a material and are easily dispersed into the binding resin. Examples include an oxide such as silicon oxide (silica), titanium oxide, zinc oxide, calcium oxide, and aluminum oxide (alumina), and a nitride compound such as silicon nitride and aluminum nitride. Especially, as a result of considering light scattering in the charge transporting layer, silicon oxide (silica) having a small difference in refractive index with a component other than the inorganic fine particles is preferable.

The added amount of the inorganic fine particles is preferably 0.005 wt % or more and less than 2 wt % to the entire solid part of the charge transporting layer because the harmful influence is less as the photoreceptor and excellent printing resistance is shown. In order to obtain a more stable printing resistance, it is more preferably 0.1 wt % or more and less than 1.8 wt %, further preferably 0.1 to 1 wt %. On the other hand, the added amount of the organic fine particles is preferably 0.005 wt % or more and less than 2 wt % to the entire solid part of the charge transporting layer. Because an increase of the organic fine particles may lower the strength of a photosensitive film, it is more preferably 0.1 to 1 wt %. The ratio of the organic fine particles to 100 parts by weight of the inorganic fine particles differs depending on the material constituting those. However, it is preferably 10 to 100 parts by weight, and more preferably 50 to 100 parts by weight.

Further, the particle size of the inorganic fine particles is preferably small in order to make light scattering and harmful influence to the charges in the system as small as possible. Specifically, particles with primary particle size of 100 nm or less are preferable, and more preferably 20 to 100 nm. On the other hand, the particle size of the organic fine particles is also preferably small in order to make light scattering and harmful influence to the charges in the system as small as possible. Specifically, particles with primary particle size of 100 nm or less are preferable, and more preferably 20 to 100 nm.

A method of adding both fine particles is preferably a method that can obtain a uniform particle dispersion state in order to sufficiently exhibit an adding effect of those. Various dispersion methods such as a ball mill, a sand mill, an attritor, a vibration mill, an ultrasonic dispersion apparatus, and a paint shaker can be used as such a method.

Various additives may be added in the charge transporting layer 13 depending on necessity. For example, in order to improve film forming property, flexibility, and surface smoothness, a plasticizer, a leveling agent, etc. may be added in the charge transporting layer 13. Examples of the plasticizer include biphenyl, biphenyl chloride, benzophenone, o-tarphenyl, dibasic acid ester (for example, phthalic ester), fatty acid ester, phosphate ester, various fluorohydrocarbon, chlorinated paraffin, and an epoxy type plasticizer. Examples of the surface reforming agent include a silicone leveling agent such as silicone oil and a fluorine resin leveling agent.

The charge transporting layer 13 can be formed, for example by preparing the paint for the charge transporting layer by dissolving or dispersing the charge transporting substance, a binding resin, filler particles, and the above-described additives in the case that there is a necessity into an appropriate solvent and by applying the obtained paint on the charge generating layer 12 in the same way as the case of forming the above-described charge generating layer 12 by coating.

Examples of the solvent of the paint for the charge transporting layer include aromatic hydrocarbon such as benzene, toluene, xylene, mesitylene, tetralin, diphenylmethane, dimethoxybenzene, monochlorobenzene, and dichlorobenzene, halogenated hydrocarbon such as dichloromethane and dichloroethane, ether such as tetrahydrofuran, dioxane, dibenzyl ether, and dimethoxymethyl ether, ketone such as cyclohexanone, acetophenone, and isophorone, ester such as methyl benzoate and ethyl acetate, a sulfur-containing solvent such as diphenylsulfide, a fluorine solvent such as hexafluoroisopropanol, and an aprotic polar solvent such as N,N-dimethylformamide. One type of these solvents may be used alone, and two or more types may be mixed and used. Further, a solvent such as alcohol, acetonitrile, and methyl ethyl ketone can be added further into the above-described solvent depending on necessity and can be used. Among these solvents, a non-halogen organic solvent can be preferably used with consideration to the global environment.

Examples of the coating method of the paint for the charge transporting layer include a spray method, a bar coat method, a roll coat method, a blade method, a ring method, and a dip coating method. Among these coating methods, especially the dip coating method is superior in various respects as described above, and therefore is often used also in the case of forming the charge transporting layer 13.

The film thickness of the charge transporting layer 13 is preferably 5 μm or more and 40 μm or less, and more preferably 10 μm or more and 30 μm or less. When the film thickness of the charge transporting layer 13 is less than 5 μm, it is not preferable because the holding ability of charges may decrease. When the film thickness of the charge transporting layer 13 exceeds 40 μm, it is not preferable because resolution of the photoreceptor 1 may decrease.

### (Photosensitive Layer)

One type or two types or more of electron-accepting substances and sensitizers such as a pigment may be added in each layer of the photosensitive layer 14 in order to attempt improvement of sensitivity and to suppress an increase of residual potential and fatigue due to repeated use.

Examples of the electron-accepting substances that can be used include acid anhydrides such as succinic anhydride, maleic anhydride, phthalic anhydride, and 4-chloronaphthalic anhydride, aldehyde such as 4-nitrobenzaldehyde, cyano compounds such as tetracyanoethylene and tetraphthalmalondititrile, anthraquinone such as anthraquinone and 1-nitroanthraquinone, polycyclic or heterocyclic nitro compounds such as 2,4,7-trinitrifluorenone and 2,4,5,7-tetranitrofluorenone, and electro-attractive materials such as a diphenoquinone compound. Further, a material in which these electro-attractive materials are polymerized can be used.

Examples of the pigment that can be used are an organic photoconductive compound such as a xanthen pigment, a thiadine pigment, a triphenylmethane pigment, a quinoline pigment, and copper phthalocyanine. These organic photoconductive compounds function as an optical sensitizer.

Further, an antioxidant, an ultraviolet ray absorbent, etc. may be added in each layer of the photosensitive layer 14. Especially, an antioxidant, an ultraviolet ray absorbent, etc. are preferably added in the charge transporting layer 13. According to that, deterioration toward oxidation gas such as ozone and nitrogen oxide can be decreased. Further, stability of the paint when forming each layer by coating can be increased.

Further, a phenol compound, a hydroquinone compound, a tocopherol compound, and an amine compound can be used as the antioxidant. Among these, a hindered phenol derivative, a hindered amine derivative, and a mixture of these can be preferably used. The used amount of these antioxidants is preferably 0.1 part by weight or more and 50 parts by weight or less in total per the charge transporting substance 100 parts by weight, and more preferably 1 to 20 parts by weight. When the used amount of the antioxidant is less than 0.1 part by weight, it is not preferable because there is a case that a sufficient effect cannot be obtained in improvement of stability of the paint and improvement of durability of the photoreceptor. Further, when it exceeds 50 parts by weight, it is not preferable because it may have harmful influence on the characteristics of the photoreceptor.

### [Configuration Example of Another Photoreceptor]

FIG. 2 is a partial cross-sectional view simplifying a configuration of an electrophotographic photoreceptor 2 that is a second embodiment of the present invention. The electrophotographic photoreceptor 2 is similar to the electrophotographic photoreceptor 1, the corresponding parts are noted with the same reference numerals, and the explanation is omitted.

A remarkable point in the electrophotographic photoreceptor 2 is that an intermediate layer (under-coating layer) 15 is provided between the conductive substrate 11 and the photosensitive layer 14.

In the case that there is no intermediate layer 15 between the conductive substrate 11 and the photosensitive layer 14, charges may be implanted from the conductive substrate 11 to the photosensitive layer 14. The surface charges other than the part that has to be removed with exposure are decreased by lowering the electrostatic property of the photosensitive layer 14, and as a result, a defect on an image such as a fogged image may be generated. Especially, in the case of forming an image using a reversal developing process, there is a case that a toner image is formed by the toner attaching to a part where the surface charges are decreased by exposure. Because of that, when the surface charges are decreased by a cause other than the exposure, a fogged image called a kuropoti of which small black spots are formed when the toner attaches on a white background may occur, and as a result, remarkable deterioration of the image quality may be generated. That is, in the case that there is no intermediate layer 15 between the conductive substrate 11 and the photosensitive layer 14, a decrease of the electrostatic property in a microscopic region occurs caused by a defect of the conductive substrate 11 or the photosensitive layer 14, and a fogged image such as a black spot is generated, and a remarkable image defect may occur.

Because the intermediate layer 15 is provided between the conductive substrate 11 and the photosensitive layer 14 as described above in the electrophotographic photoreceptor 2, charge implantation from the conductive substrate 11 to the photosensitive layer 14 can be prevented. Therefore, a lowering of the electrostatic property of the photosensitive layer 14 can be prevented, a decrease of the surface charges other than the part that has to be removed with exposure can be suppressed, and generation of defects such as a fogged image can be prevented.

Further, because a uniform surface can be obtained by coating the defect on the surface of the conductive substrate 11 by providing the intermediate layer 15, the film forming property of the photosensitive layer 14 can be improved. Further, peeling of the photosensitive layer 14 from the conductive substrate 11 can be suppressed, and adhesiveness of the conductive substrate 11 with the photosensitive layer 14 can be improved.

A resin layer made of various resin materials or an alumite layer can be used as the intermediate layer 15.

Examples of the resin material constituting the resin layer include resins such as a polyethylene resin, a polypropylene resin, a polystyrene resin, an acrylic resin, a vinylchloride resin, a vinyl acetate resin, a polyurethane resin, an epoxy resin, a polyester resin, a melamine resin, a silicone resin, a polyvinylbutyral resin, and a polyamide resin, and copolymerized resins containing two or more repeated units configuring these resins. Further, examples also include casein, gelatin, polyvinyl alcohol, and ethyl cellulose. Among these resins, a polyamide resin is preferably used, and especially an alcohol-soluble nylon resin is preferably used. Preferable examples of the alcohol-soluble nylon resin include a so-called copolymer nylon such as 6-nylon, 11-nylon, 12-nylon, 6,6-nylon, 6,10-nylon, and 2-nylon and a resin in which nylon is chemically modified such as N-alkoxymethyl modified nylon and N-alkyoxyethyl modified nylon.

The intermediate layer 15 may contain metal oxide particles. Because the volume resistance value of the intermediate layer 15 can be adjusted by containing the particles in the intermediate layer 15, the effect of preventing implantation of the charges from the conductive substrate 11 to the photosensitive layer 14 can be improved. In addition, electronic characteristics of the photoreceptor can be maintained under various environments. The particle size is preferably in the range of 0.02 to 0.5 μm.

An example of the metal oxide particles is particles such as titanium oxide, aluminum oxide, aluminum hydroxide, and tin oxide.

The intermediate layer 15 is formed, for example, by preparing a paint for the intermediate layer by dissolving or dispersing the above-described resins into an appropriate solvent and by applying this paint on the surface of the conductive substrate 11. In the case of containing the above-described metal oxide particles, etc. in the intermediate layer 15, the paint for the intermediate layer is prepared by dispersing these particles into a resin solution obtained by dissolving the above-described resins into an appropriate solvent for example. Then, the intermediate layer 15 can be formed by applying this paint on the surface of the conductive substrate 11.

Water, various organic solvents, or these mixed solvents can be used for the solvent of the paint for the intermediate layer. For example, a single solvent such as water, methanol, ethanol, and butanol, or a mixed solvent of water and alcohol, two types of alcohols, acetone, dioxane, etc. and alcohol, a chlorine solvent such as dichloroethane, chloroform and trichloroethane and alcohol is used. A non-halogen type organic solvent can preferably used among these solvents with a concern toward the global environment.

A general method using a ball mill, a sand mill, an attritor, a vibration mill, an ultrasonic dispersion apparatus, a paint shaker, etc. can be used as the method of dispersing the above-described particle into the resin solution.

In the paint for the intermediate layer, the ratio C/D of the total weight C of the resin and the metal oxide to the weight D of the solvent used in the paint for the intermediate layer is preferably 1/99 to 40/60, and more preferably 2/98 to 30/70. Further, the ratio E/F of the weight E of the resin to the weight F of the metal oxide is preferably 90/10 to 1/99, and more preferably 70/30 to 5/95.

Examples of the coating method of the paint for the intermediate layer include a spray method, a barcoating method, a roll coating method, a blade method, a ring method, and a dip coating method. Among these, because the dip coating method is relatively simple as described above, and is superior in productivity and in the respect of raw cost, it is often used also in the case of forming the intermediate layer 15.

The film thickness of the intermediate layer 15 is preferably 0.01 μm or more and 20 μm or less, and more preferably 0.05 μm or more and 10 μm or less. When the film thickness of the intermediate layer 15 is thinner than 0.01 μm, it becomes difficult to practically function as the intermediate layer 15, and it becomes difficult to obtain uniform surface property by coating the defect in the conductive substrate 11. As a result, it is not preferable because it becomes difficult to prevent the implantation of the charges from the conductive substrate 11 to the photosensitive layer 14 and a lowering of the electrostatic property of the photosensitive layer 14 may occur. To make the film thickness thicker than 20 μm is not preferable because the formation of the intermediate layer 15 becomes difficult and the photosensitive layer 14 cannot be formed uniformly on the intermediate layer 15 in the case of forming the intermediate layer 15 with a dip-coating method, and there is a case that sensitivity of the photoreceptor decreases.

### (Manufacturing Method of Photoreceptor)

In the manufacturing of the photoreceptor, a drying step is preferably included in every formation of each layer of preferably the charge generating layer 12, the charge transporting layer 13, the intermediate layer 15, etc. The drying temperature of the photoreceptor is appropriately about 50° C. to about 140° C., and especially the range of about 80° C. to about 130° C. is preferable. When the drying temperature of the photoreceptor is less than about 50° C., it is not preferable because the drying time becomes long or because the solvent remains in the photosensitive layer without sufficiently evaporating. Further, when the drying temperature exceeds about 140° C., it is not preferable because electronic characteristics deteriorate upon repeated use and the image obtained using the photoreceptor may deteriorate.

### (Toner)

Next, a dry-type magnetic toner that can be used in the present invention is explained. A toner is coloring particles containing a binding resin, a coloring agent, a wax, an electrostatic controlling agent, and other additives depending on necessity.

The binding resin used in the toner includes polystyrene, a styrene-acrylic copolymer, a styrene-acrylonitrile copolymer, a styrene-maleic anhydride copolymer, a styrene-acrylic-maleic anhydride copolymer, polyvinyl chloride, a polyolefin resin, an epoxy resin, a silicone resin, a polyamide resin, a polyurethane resin, a urethane modified polyester resin, and an acrylic resin. These resins may be used alone or may be mixed and used. These resins may be a block polymer or a graft polymer. Further, all the resins having a known molecular weight distribution for a toner such as a resin having a molecular weight distribution of a one peak or a two peak distribution can be used for these binding resins.

Further, a resin having its glass transition point Tg of 40° C. to 70° C. is good for the binding resin. With a resin having a glass transition point of 40° C. or less, there is high possibility that the resin melts and cohesion of toners occurs in the case that the temperature in the apparatus increases. Further, with a resin having a glass transition point of 70° C. or more, it is not preferable because fixing performance may deteriorate.

All agents conventionally known as a toner can be used as the coloring agents. Carbon black, iron black, an alloy azo dye, other various oil-soluble dyes and pigments, etc. can be used as the coloring agent, and it is desirable to add these coloring agents at 1 to 10 parts by weight to the resin component 100 parts by weight.

The wax is preferably at least one kind selected from the group of polyolefin waxes such as polyethylene, polypropylene, and an ethylene-propylene copolymer. It is desirable to contain the wax at 1 to 10 parts by weight to the resin component 100 parts by weight.

There are two types of electrostatic controlling agent that are for positive electrostatic and for negative electrostatic. Examples of the electrostatic controlling agent include an azo dye, a carboxylic acid metal complex, a quaternary ammonium compound, and a nigrosine dye. It is desirable to add these electrostatic agents at 0.1 to 5 parts by weight to the resin component 100 parts by weight.

Another additive is inorganic fine particles. Examples of the inorganic fine particles are metal oxide fine particles such as silica, titanium, alumina, magnetite, and ferrite, fine powder of a metal nitride fine particles etc. such as silicon nitride and boron nitride. Furthermore, particles in which a silane coupling treatment of dimethyldichlorosilane, aminosilane and a silicone oil treatment are performed on the surface of these fine powders, particles in which a fluorine-containing component is given, etc. can be used. One type of these fine particles may be used, or a plurality of types may be mixed and used. The inorganic fine particles are preferably conductive inorganic fine particles, and especially magnetite particles are desirable.

The latent image formed on the photosensitive layer becomes a toner image by being developed in contact or non-contact with a magnetic or a non-magnetic one component developer or two component developer. In any of the cases of contact and non-contact, a reversal developing method can be adopted in which a light-area potential irradiated by light is developed.

A method of transferring a toner image of the photosensitive layer onto a normal paper includes a method by a corona discharge and a method using a transferring roller, and it may be any method. Further, heat fixing, a pressure fixing, etc. generally adapted is used for the fixing of the toner image onto a normal paper.

### (Electrophotographic Apparatus)

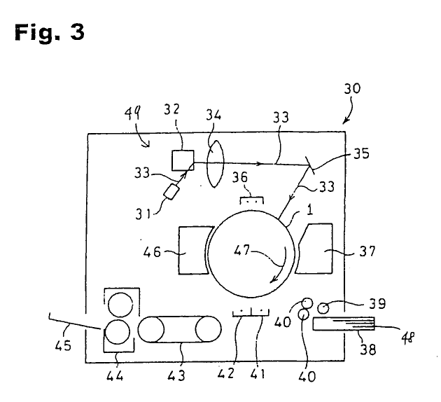

FIG. 3 is an arrangement side view simplifying a configuration of an electrophotographic apparatus 30 in the present invention. The electrophotographic apparatus 30 shown in FIG. 3 is a laser printer loaded with the photoreceptor 1. The configuration and an image forming operation of the laser printer 30 are explained by referring to FIG. 3 below. Moreover, the laser printer 30 described in FIG. 3 is only an example of the electrophotographic apparatus in the present invention, and the electrophotographic apparatus in the present invention is not limited by the content described below.

The laser printer 30, that is an electrophotographic apparatus, is configured by including the photoreceptor 1, a semiconductor laser 31, a rotary polygon mirror 32, an image forming lens 34, a mirror 35, a corona electrifier 36 that is a charging means, a developing unit 37 that is a developing means, a transfer paper cassette 38, a paper supplying roller 39, a resist roller 40, a transfer electrifier 41 that is a transferring means, a separation electrifier 42, a conveyance belt 43, a fixing unit 44, a paper delivery tray 45, and a cleaner 46 that is a cleaning means. The semiconductor laser 31, the rotary polygon mirror 32, the image forming lens 34, and the mirror 35 configure an exposing means 49. A light-emitting diode may be used instead of the semiconductor laser.

The photoreceptor 1 is mounted in the laser printer 30 so that it can rotate in the direction of an arrow 47 by a driving means that is not shown in the figure. A laser beam 33 radiated from the semiconductor laser 31 is repeatedly scanned in its longitudinal direction (the main scanning direction) to the surface of the photoreceptor 1 with the rotary polygon mirror 32. The image forming lens 34 has a f-θ characteristic, and exposes by reflecting the laser beam 33 with the mirror 35 and by forming an image on the surface of the photoreceptor 1. By forming an image by scanning the laser beam 33 as described above while rotating the photoreceptor 1, an electrostatic latent image corresponding to the image information is formed on the surface of the photoreceptor 1.

The above described corona electrifier 36, the developing unit 37, the transfer electrifier 41, the separation electrifier 42, and the cleaner 46 are provided from the upstream side toward the downstream side of the rotation direction of the photoreceptor 1 shown by the arrow 47 in this order. The corona electrifier 36 is provided on the upstream side of the rotation direction of the photoreceptor 1 than the image forming point of the laser beam 33, and uniformly electrifies the surface of the photoreceptor 1. Therefore, the laser beam 33 is to expose the surface of the photoreceptor 1 uniformly electrified, a difference between the electrified amount of the part exposed by the laser beam 33 and the electrified amount of the part non-exposed is generated, and the above-described electrostatic latent image is formed.

The developing unit 37 is provided closer to the downstream side of the rotation direction of the photoreceptor 1 than the image forming point of the laser beam 33, supplies a toner to the electrostatic latent image formed on the surface of the photoreceptor 1, and develops the electrostatic latent image as a toner image. A transfer paper 48 stored in the transfer paper cassette 38 is taken out one by one with the paper supplying roller 39, and it is given to the transfer electrifier 41 by synchronizing with the exposure to the photoreceptor 1 with the resist roller 40. The toner image is transferred onto the transfer paper 48 with the transfer electrifier 41. The separation electrifier 42 provided by being adjacent to the transfer electrifier 41 separates the transfer paper in which the toner image is transferred from the photoreceptor 1 by discharging.

The transfer paper 48 separated from the photoreceptor 1 is conveyed to the fixing unit 44 with the conveyance belt 43, and the toner image is fixed with the fixing unit 44. The transfer paper 48 in which the image is formed in such manner is delivered to the paper delivery tray 45. Moreover, after the transfer paper 48 is separated with the separation electrifier 42, a foreign object such as the remaining toner paper powder on the surface of the photoreceptor 1 that is continuing the rotation further is cleaned with the cleaner 46. The photoreceptor 1 whose surface is cleaned with the cleaner 46 is discharged with a discharge lamp provided together with the cleaner 46, that is not shown in the figure, further being rotated, and a series of the image forming operation starting from charging of the photoreceptor 1 described above is repeated.

### EXAMPLES

The present invention is explained further in detail using examples below. However, the present invention is not limited to the content described below.

### Production Example of Photoreceptor 1

A paint for an under-coating layer was prepared by performing a dispersion treatment on titanium oxide TTO-MI-1 (trade mark, manufactured by Ishihara Sangyo Kaisha, Inc.) 3 parts by weight, an alcohol-soluble nylon resin CM-8000 (trade mark, manufactured by Toray Industries, Inc.) 3 parts by weight, methanol 60 parts by weight, and 1,3-dioxolane 40 parts by weight for 10 hours with a paint shaker. An under-coating layer was formed by applying the prepared paint for an under-coating layer on an aluminum cylindrical supporter of 30 mm diameter and 340 mm long so as to form a film with a film thickness of 0.9 μm with a dip-coating method.

Next, a paint for a charge generating layer was produced by dispersing a butyral resin (trade mark: S-LEC BM-2, manufactured by Sekisui Chemical Co., Ltd.) 10 parts by weight, a 1,3-dioxolane 1400 parts by weight, and titanylphthalocyanine shown in the structural formula (B) (for example, it is produced with a known method described in Patent Registration No. 3569422) 15 parts by weight for 72 hours with a ball mill. A charge generating layer was formed by applying this paint on an aluminum cylindrical supporter provided with the above-described under-coating layer so as to form a film with a film thickness of 0.2 μm with a dip-coating method.

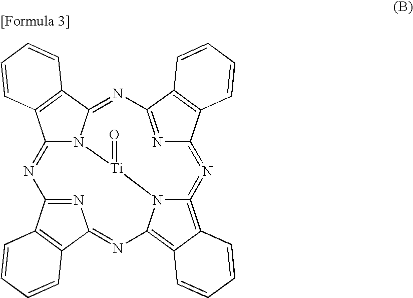

Next, a polycarbonate resin TS2040 (manufactured by Teijin Chemicals, Ltd.) 0.025 part by weight, fluorine-containing resin particles (Nissan Electol MC-2: manufactured by NOF Corporation, particle size 5.0 μm, organic fine particles) 0.025 part by weight, and silica (TS-610: manufactured by Cabot Specialty Chemicals, Inc., particle size 17 nm, inorganic fine particles) 0.025 part by weight were mixed into tetrahydrofuran 0.45 part by weight. The particle size of the fine particles was a value measured using a Coulter Multisizer (manufactured by Beckman Coulter, Inc.). A primary dispersion paint for a charge transporting layer was prepared by performing a dispersion treatment on the obtained mixture with a ball mill for 5 hours. Next, a butadiene compound represented with the following structural formula (2) (T-405 manufactured by Takasago International Corporation) as a charge transporting substance 100 parts by weight, a polycarbonate resin TS2040 139.9 parts by weight, and an antioxidant (Sumilizer BHT: manufactured by Sumitomo Chemical Co., Ltd.) 5 parts by weight were mixed and dissolved into tetrahydrofuran 984 parts by weight. A secondary dispersion paint for a charge transporting layer was prepared by mixing the above-described primary dispersion paint for a charge transporting layer into this dissolved liquid and performing a stirring treatment for 1 hour. The photoreceptor 1 of the Production Example 1 was obtained by applying this paint onto the above-described charge generating layer with a dip-coating method, drying at 130° C. for 1 hour, and forming a charge transporting layer of a layer thickness 28 μm.

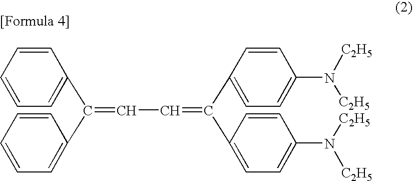

### Production Example of Photoreceptor 2

A photoreceptor 2 was produced in the same manner as the Production Example of Photoreceptor 1 except that the filler particles as inorganic fine particles were changed to alumina particles (Sumicorundum AA-04: manufactured by Sumitomo Chemical Co., Ltd., particle size 0.4 μm).

### Production Example of Photoreceptor 3

A photoreceptor 3 was produced in the same manner as the Production Example of Photoreceptor 1 except that the filler particles as inorganic fine particles were changed to silica particles (X-24-9163A: manufactured by Shin-Etsu Chemical Co., Ltd., particle size 100 μm).

### Production Example of Photoreceptor 4: Comparative

A photoreceptor 4 was produced in the same manner as the Production Example of Photoreceptor 1 except that organic fine particles and inorganic fine particles were not added.

### Production Example of Photoreceptor 5: Comparative

A photoreceptor 5 was produced in the same manner as the Production Example of Photoreceptor 1 except that organic fine particles were not added and inorganic fine particles were added.

### Production Example of Photoreceptor 6: Comparative

A photoreceptor 6 was produced in the same manner as the Production Example of Photoreceptor 1 except that inorganic fine particles were not added and organic fine particles were added.

### Production Example of Photoreceptor 7

A photoreceptor 7 was produced in the same manner as the Production Example of Photoreceptor 1 except the charge transporting substance was changed to a hydrazone compound (manufactured by Mitsubishi Chemical Corporation) represented by the following formula (3):

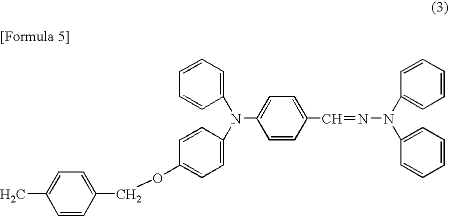

### Production Example of Toner 1

A polyester resin “HIMER” (manufactured by Sanyo Chemical Industries, Ltd.) 100 parts by weight as a binder resin, carbon black “MOGUL L” (manufactured by Cabot Corporation) 5 parts by weight, a polypropylene wax “VISCOL 550” (manufactured by Sanyo Chemical Industries, Ltd., melting point: 140° C.) 5 parts by weight, magnetite “EPT500” (manufactured by Toda Kogyo Corp.) 80 parts by weight as a magnetic powder, and a charge controlling agent “S-34” (manufactured by Orient Chemical Industries, Ltd.) 1 part by weight were mixed with a Henschel mixer and then melt-kneaded with a biaxial extruder. The obtained melt-kneaded substance was pulverized and classified so that the weight average particle size (measured using a Coulter Multisizer (manufactured by Beckman Coulter, Inc.)) became 8 μm using a high speed jet mill pulverizing classifier “IDS-2 type” (manufactured by Nippon Pneumatic Mfg. Co, Ltd.)

A toner 1 was obtained by adding a hydrophobic silica “R-976S” (manufactured by Nippon AEROSIL Co., Ltd.) 0.5 part by weight into the obtained powder 100 parts by weight and mixing with a Henschel mixer. The electrification amount of this toner was measured with a frictional electrification amount measuring method described below, and found to be 20 μc/g.

### [Measuring Method of Frictional Electrification Amount of Toner]

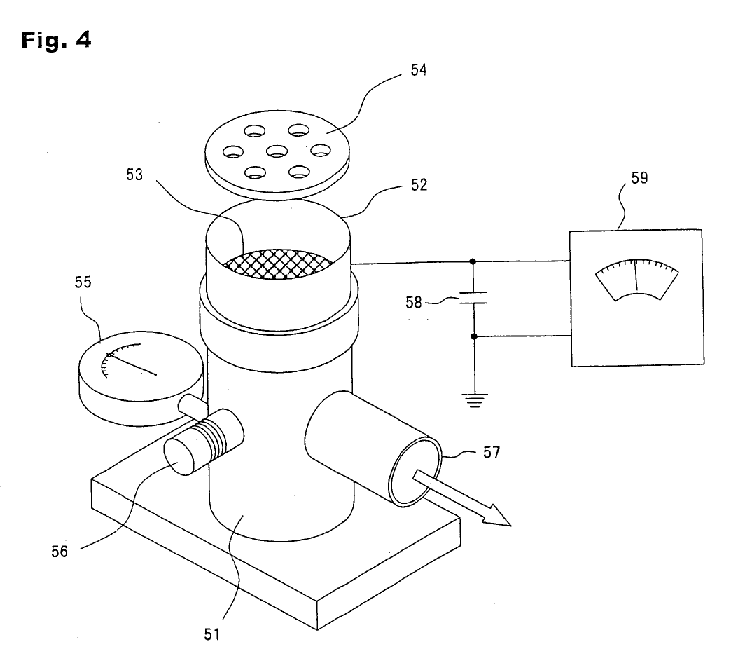

FIG. 4 is an explanatory drawing of a device measuring the frictional electrification amount. About 0.5 to 1.5 g of a two-component developer extracted from a developing sleeve of a copier or a printer is placed in a metal measurement container 52 having a 500 mesh screen 53 at the bottom, and a metal lid 54 is put on. The total weight of the measurement container 52 at this time is weighted and made to be W₁ (g). Next, at a suction machine 51 (the part contacting to the measurement container 52 is at least an insulator), the pressure of a vacuum meter 55 is made to be 250 mmAq by sucking from a suction port 57 and adjusting an airflow control valve 56. The toner is sucked and removed by performing suction sufficiently, preferably for 2 minutes in this condition. The potential in a potential meter 59 at this time is designated as V (volt). Here, 58 is a capacitor, and the capacitance is designated as C (mF). Further, a weight of the entire measurement container 52 after the suction is weighed and made to be W₂ (g). The frictional electrification amount (mC/kg) of this sample is calculated as in the following formula.

Frictional Electrification Amount of the Sample(mC/kg)=C×V/(W₁−W₂)

(provided that the measurement condition is 23° C. and 60% RH).

A coat ferrite carrier having 70 to 90% by mass of carrier particles of 250 mesh passable and 350 mesh impassable is used as the carrier that is used in the measurement.

### Production Example of Toner 2

A toner 2 was obtained in the same manner as Production Example of Toner 1 except 1 part by weight of hydrophobic silica was used. The electrification amount of this toner was 28 μc/g.

### Production Example of Toner 3

A toner 3 was obtained in the same manner as Production Example of Toner 1 except 0.25 part by weight of hydrophobic silica was used. The electrification amount of this toner was 10 μc/g.

### Production Example of Toner 4

A toner 4 was obtained in the same manner as Production Example of Toner 1 except 1.5 parts by weight of hydrophobic silica was used. The electrification amount of this toner was 33 μc/g.

### Production Example of Toner 5

A toner 5 was obtained in the same manner as Production Example of Toner 1 except 0.2 part by weight of hydrophobic silica was used. The electrification amount of this toner was 8 μc/g.

A judgment of film thinning and a judgment of image deterioration were performed on Examples 1 to 5 and Comparative Examples 1 to 5 in which the above-described photoreceptors and toners were used.

[Judgment of Film Thinning]

An amount of film thinning per 100 k (100,000) rotations was obtained by loading the photoreceptor and the toner in a digital copier AR-451 manufactured by Sharp Corporation and performing a printing resistance test of 200,000 papers. The printing resistance was evaluated from the obtained amount of film thinning with the following criteria. It means that the greater amount of film thinning there is, the poorer the printing resistance is.

<Judgment Criteria>

⊚: Amount of Film Thinning d<0.7 μm/100 k rotations

◯: 0.7 μm/100 k rotations≦Amount of Film Thinning d<0.9 μm/100 k rotations

X: 0.9 μm/100 k rotations≦Amount of Film Thinning d

[Judgment of Image Deterioration]

In order to investigate deterioration level of image quality of the photoreceptor after printing, unevenness of the concentration in a half tone image was evaluated. The unevenness of the concentration was evaluated with the following judgment criteria. It means that the more unevenness of the concentration there is, the more deteriorated the image is.

◯: No unevenness of the concentration in the image by visual observation. Good image.

X: Unevenness of the concentration in the image by visual observation. At the level that it becomes a problem in practical use.

[Overall Evaluation]

Judgment is performed as follows based on the judgment result of the above-described two items.

⊚: Two items are ⊚, or one item is ⊚ and another item is ◯.

◯: Two items are ◯.

X: At least one item or more is X.

### Example 1

The judgment of film thinning and the judgment of image deterioration were performed using the photoreceptor 1 and the toner 1. A good result is obtained in all judgments, and there was an effect on especially the film thinning.

### Example 2

The judgment of film thinning and the judgment of image deterioration were performed using the photoreceptor 2 and the toner 1. A good result was obtained in all judgments, and there was an effect on especially the film thinning.

### Example 3

The judgment of film thinning and the judgment of image deterioration were performed using the photoreceptor 3 and the toner 1. A good result was obtained in all judgments, and there was an effect on especially the film thinning.

### Example 4

The judgment of film thinning and the judgment of image deterioration were performed using the photoreceptor 1 and the toner 2. Some deterioration in the image concentration was observed. However, a roughly good result was obtained.

### Example 5

The judgment of film thinning and the judgment of image deterioration were performed using the photoreceptor 1 and the toner 3. Some fogging due to toner scattering was observed. However, a roughly good result was obtained.

### Example 6

The judgment of film thinning and the judgment of image deterioration were performed using the photoreceptor 7 and the toner 1. Some fogging due to toner scattering was observed. However, a roughly good result was obtained.

### Comparative Example 1

The judgment of film thinning and the judgment of image deterioration were performed using the photoreceptor 4 and the toner 1. The result was that the amount of film thinning was remarkably large, and that the judgment of image deterioration was also very poor.

### Comparative Example 2

The judgment of film thinning and the judgment of image deterioration were performed using the photoreceptor 5 and the toner 1. Inferior cleaning caused by the property of the photoreceptor surface.

### Comparative Example 3

The judgment of film thinning and the judgment of image deterioration were performed using the photoreceptor 6 and the toner 1. The amount of film thinning was large.

### Comparative Example 4

The judgment of film thinning and the judgment of image deterioration were performed using the photoreceptor 1 and the toner 4. As the number of printed papers increases, a remarkable decrease of the image concentration occurred.

### Comparative Example 5

The judgment of film thinning and the judgment of image deterioration were performed using the photoreceptor 1 and the toner 5. As the number of printed papers increased, a remarkable toner scattering occurred in the apparatus, and it leaded to a result that fogging was very poor.

Types and particle sizes of the organic fine particles and the inorganic fine particles, the toner charge amount, the judgment of film thinning, judgment of image deterioration, and overall evaluation of Examples 1 to 6 and Comparative Examples 1 to 5 are shown in Table 1.

TABLE 1

| | | | | | Frictional | | | | |
|---|---|---|---|---|---|---|---|---|---|
| | | | inorganic | | Electrification | Film | | Judgment | |
| | organic fine particles | | fine particles | | Amount | Thinning | | of | |
| | | particle | | particle | of Toner | μm/100k | | Image | Overall |
| | type | size μm | type | size μm | μC/g | rotations | Judgment | Deterioration | Evaluation |
| EX. 1 | fluorine-containing resin | 5.0 | silica | 17 | 20 | 0.62 | ⊚ | ◯ | ⊚ |
| EX. 2 | ↑ | ↑ | alumina | 0.4 | 20 | 0.64 | ⊚ | ◯ | ⊚ |
| EX. 3 | ↑ | ↑ | silica | 100 | 20 | 0.59 | ⊚ | ◯ | ⊚ |
| EX. 4 | ↑ | ↑ | ↑ | 17 | 28 | 0.85 | ◯ | ◯ | ◯ |
| EX. 5 | ↑ | ↑ | ↑ | ↑ | 10 | 0.77 | ◯ | ◯ | ◯ |
| EX. 6 | ↑ | ↑ | ↑ | ↑ | 20 | 0.88 | ◯ | ◯ | ◯ |
| COM. EX. 1 | — | — | — | — | 20 | 1.35 | X | X | X |
| COM. EX. 2 | — | — | silica | 17 | 20 | 0.84 | ◯ | X | X |
| COM. EX. 3 | fluorine-containing resin | | — | — | 20 | 1.51 | X | ◯ | X |
| COM. EX. 4 | ↑ | ↑ | silica | 17 | 8 | 0.86 | ◯ | X | X |
| COM. EX. 5 | ↑ | ↑ | ↑ | ↑ | 33 | 0.88 | ◯ | X | X |

According to the present invention, an electrophotographic apparatus is provided that is superior in printing resistance, maintains electrical stability over a long term of use, and can steadily supply an image in which degradation etc. do not occur. That is, releasability of toner can be given by adding organic fine particles in the foremost surface layer. Further, by ensuring mechanical strength of the foremost surface layer by adding inorganic fine particles, as a result, a high quality image can be obtained over a long term.

What is claimed is:

1. An electrophotographic apparatus comprising an electrophotographic photoreceptor having the foremost layer containing organic fine particles and inorganic fine particles, which uses a dry-type magnetic toner having a charge amount of 10.0 μc/g or more and 30.0 μc/g or less.

2. The electrophotographic apparatus of claim 1, wherein the organic fine particles are fluorine-containing resin fine particles.

3. The electrophotographic apparatus of claim 1, wherein the inorganic fine particles are aluminum oxide particles or silicon oxide particles.

4. The electrophotographic apparatus of claim 1, wherein the inorganic fine particles have the particle size of 100 nm or less.

5. The electrophotographic apparatus of claim 1, wherein the foremost layer further comprises polycarbonate as a binder resin.

6. The electrophotographic apparatus of claim 1, wherein the foremost layer is a charge transporting layer, which contains the organic fine particles and inorganic fine particles of 0.005 to 1 wt % and 0.005 to 1 wt %, respectively, to the entire solid part of the charge transporting layer, the organic fine particles have a ratio of 10 to 100 parts by weight to 100 parts by weight of the inorganic fine particles.

7. The electrophotographic apparatus of claim 6, wherein a charge transporting substance using the charge transporting layer is a substance containing an aromatic ring group having a butadienyl group.

8. The electrophotographic apparatus of claim 2, wherein the fluorine-containing resin fine particles are made from polyethylene fluoride, polypropylene fluoride, polyvinylidene fluoride or ethylene fluoride-ethylene copolymer resin.

9. The electrophotographic apparatus of claim 1, wherein the organic fine particles have the particle size of 100 nm or less.

10. The electrophotographic apparatus of claim 6, wherein the charge transporting layer have the film thickness of 5 μm or more and 40 μm or less.
